(19) United States
(12) Patent Application Publication
(10) Pub. No.: US 2010/0267854 A1
(43) Pub. Date: Oct. 21, 2010

(54) POLYURETHANE FOAM CONTAINING SILICONE

(75) Inventors: Jens Cremer, Munich (DE); Peter Ball, Emmerting (DE); Volker Stanjek, Ampfing (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/738,692

(22) PCT Filed: Dec. 1, 2008
(86) PCT No.: PCT/EP08/66538

§ 371 Date: Apr. 19, 2010

(30) Foreign Application Priority Data
Dec. 4, 2007 (DE) 10 2007 055 703.7

(51) Int. Cl. C08J 9/06; C08G 77/26

(52) U.S. Cl. 521/154; 528/28

(57) ABSTRACT

Silicone-containing polyurethane foams of low density may be prepared from hyperbranched siloxanes.

The invention relates to foamable compositions based on organosilicon compounds, to hyperbranched siloxanes contained therein, to silicone-containing polyurethane foams with low densities, and to processes for their preparation.

Polyurethane foams are generally prepared by reaction of a polyisocyanate with compounds containing two or more active hydrogen atoms. The compounds containing active hydrogen are typically polyols, primary and secondary polyamines, and water. Between these reactants there are two principal reactions that occur during the preparation of a polyurethane foam. These reactions must in principle run simultaneously and with a competitively balanced rate during the operation, in order to produce a polyurethane foam having desired physical properties. The reaction between the isocyanate and the polyol or polyamine, which is typically termed a gel reaction, leads to the formation of a polymer with a high molecular weight. The progress of this reaction increases the viscosity of the mixture and contributes generally to the formation of crosslinking with polyfunctional polyols. The second principal reaction takes place between the polyisocyanate and water. This reaction contributes to the growth of the urethane polymer and is important for the formation of carbon dioxide gas, which assists the foaming process. Consequently this reaction is often termed the blowing reaction. Both the gel reaction and the blowing reaction take place in foams which are blown partially or completely with carbon dioxide gas. If, for example, the evolution of carbon dioxide is too rapid by comparison with the gel reaction, the foam exhibits a proclivity to collapse. If, alternatively, the gel expansion reaction is too rapid as compared with the blow reaction that produces carbon dioxide, foam rise is limited, and a high-density foam is produced. Similarly, poorly matched crosslinking reactions will impact adversely on foam stability. The polyols used are generally polypropylene glycols, which in accordance with the prior art can be prepared in a very wide variety of topologies, and differ from one another in molecular weight, degree of branching, and OH number. In spite of the broad structural variation of these polyols and the associated tailoring of the polyurethane foams to virtually any application, the inherent flammability of the commercially available polyurethane foams is a serious drawback. In spite of great efforts, success has so far not been achieved in establishing absolutely inflammable flexible PU foams on the market, although in recent decades there has been no lack of intense research activities aimed at improving the flame retardancy properties of polymer foams.

One route to flame-retarded, flexible PU foams is taken with the silicone-polyurethane flexible foams. In such foams, the highly combustible polyol component that is used in standard PU foams is replaced by incombustible, OH-terminated siloxanes. Through the use of silicone-polyurethane copolymers, i.e., of polysiloxanes, which also contain polyurethane units and/or urea units, it is possible to develop incombustible foam materials of this kind which have new combinations of properties that are tailored precisely to the particular application.

Reference on this point may be made, for example, to EP 1485419 B1, which describes the preparation of silicone-polyurethane foams starting from alkylamino- or alkylhydroxy-terminated silicone oils and diisocyanates in what is called a “one-shot” process. Furthermore, DE 102006013416 A1 describes the preparation of silicone-PU foams from prepolymers which are prepared in a solvent-based operation on the basis of alkylamino- or alkylhydroxy-terminated silicone oils and diisocyanates.

A feature which unites the silicone-polyurethane foams that have been described to date is that they are prepared on the basis of siloxanes which are linear or have only very slight, but statistical, branching in the side chains. In view of this linear siloxane chain, the rise phase during foaming is not accompanied by an increase in molar mass, and so the increase in viscosity during the rise phase is relatively slow, meaning that the polymer matrix, even after the end of the blowing reaction, is generally slightly fluid, and, therefore, the fine cell structure may still collapse before curing of the foam is complete. Even if only a small fraction of the cell structure collapses in on itself, the result is a coarse and irregular cell distribution.

In order to counteract cell collapse when using linear polyol components, the struts connecting the individual foam cells must not fall below a critical diameter during the rise phase. Hence it is ensured that the still fluid polymatrix is able to counteract the threat of collapse of the foam structure. If, however, the desired foam density selected is too low, then the cell struts become increasingly thin during the rise phase until, finally, they become too flexible to stabilize the cell structure. Accordingly, in general, linear siloxanes result only in silicone-PU foams having densities of well above 100 kg/m³.

Hyperbranched polymers are already known and are discussed exhaustively, for example, in the review article by C. Gao, D. Yan; Prog. Polym. Sci., 2004, 24, 183-275, in relation to synthesis, properties, and applications. Hyperbranched polymers are a subset of dendritic macromolecules, and possess greater branching than conventionally branched polymers, which primarily have primary or secondary branches on a linear main chain. To date, for the synthesis of hyperbranched polymers, divergent synthesis methods have been employed, where a monomer possessing just two different kinds of functional groups that react with one another, but not with themselves, the functionality of the monomers being in total greater than two. Examples of suitable monomers are those which possess one functional group A and two functional groups B, i.e., a AB₂ monomer. In principle it is possible to use all monomers ABₓ where x>1. The use of ABₓ monomers in a monomolecular polymerization, however, is possible only when the A and B groups react with one another only when such reaction is desired in the polymer synthesis, in other words following addition of a catalyst or as a result of an increase in temperature. An alternative possibility is for hyperbranched polymers to be synthesized with two different types of monomer each having only one kind of functional groups, but in different numbers, such as A₃ and B₂ units, for example. Through a reaction of these two A₃ and B₂ types it is then possible in situ to obtain A₂B and AB₂ monomer blocks (di-molecular polymerization: generally with Aₓ and B_{y}, where x>1 and y>2). Processes of this kind are general knowledge and are described, for example, in U.S. Pat. No. 6,534,600.

The invention provides foamable compositions which comprise hyperbranched siloxanes (A) of the formula

V—(R²)ₚ₋ₘ([SiR₂O]ₙ—SiR₂R¹)ₘ (I)

in which

V is a radical of value p,

R can be identical or different and is a monovalent, optionally substituted hydrocarbon radical,

R¹ can be identical or different and is a monovalent hydrocarbon radical which is substituted by at least one isocyanate group, and which may be interrupted by heteroatoms,

R² can be identical or different and represents monovalent radicals,

n is an integer greater than or equal to 1, preferably 1 to 1000, more preferably 5 to 500, more particularly 10 to 100,

p is an integer greater than or equal to 3, preferably 3 to 20, more preferably 3 or 4, and

m is an integer greater than or equal to 3, preferably 3 to 20, more preferably 3 to 4,

with the proviso that p is greater than or equal to m.

Examples of R are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical; alkenyl radicals, such as the vinyl and the allyl radical; cycloalkyl radicals, such as cyclopentyl, cyclohexyl, cycloheptyl radicals and methylcyclohexyl radicals; aryl radicals, such as the phenyl and the naphthyl radical; alkaryl radicals, such as o-, m-, p-tolyl radicals, xylyl radicals, and ethylphenyl radicals; aralkyl radicals, such as the benzyl radical, the α- and the β-phenylethyl radical.

Examples of substituted hydrocarbon radicals R are methoxymethylene radicals, ethoxymethylene radicals, dimethylaminomethylene and diethylaminomethylene radicals.

Preferably radical R comprises monovalent, optionally substituted hydrocarbon radicals having 1 to 40 carbon atoms, more preferably hydrocarbon radicals having 1 to 30 carbon atoms, more particularly hydrocarbon radicals having 1 to 6 carbon atoms.

Radical R¹ preferably comprises those of the formula

—Yₐ-A-C(O)—NH—Z—NCO (II)

where

Y and Z independently of one another are divalent, optionally substituted hydrocarbon radicals which may be interrupted by heteroatoms,

A has the definition of —O— or —NR³—, where R³ is hydrogen atom or monovalent, optionally substituted hydrocarbon radical and

a is 0 or 1.

Examples of R³ are hydrogen atom and the examples given for radical R.

Preferably radical R³ is hydrogen atom.

Preferably radical A is the radical —NR³—, where R³ is as defined above.

Examples of radicals Y and Z are, in each case independently of one another, ethylene radicals, propylene radicals, butylene radicals, pentylene radicals, hexamethylene radicals, methyloxyethylene radicals, tolylene radicals, methylene-bis-phenylene radicals, phenylene radicals, naphthylene radicals, cyclohexylene radicals, and isophorone radicals.

Preferably Y comprises divalent, aliphatic, optionally —NCO-substituted hydrocarbon radicals which may be interrupted by heteroatoms, more preferably propylene and methyloxyethylene radicals, more particularly methyloxyethylene radicals.

Preferably Z comprises divalent, aromatic, optionally —NCO-substituted hydrocarbon radicals which may be interrupted by heteroatoms, more preferably toluenylene and methylene-bis-phenylene radicals, more particularly toluenylene radicals.

Most preferably, a is 1.

Examples of radicals R² are hydrogen atom, organyloxy radicals, such as methoxy radicals, ethoxy radicals, and phenoxy radicals, optionally substituted hydrocarbon radicals, such as, for example, the examples given for radical R, organyloxymethylene radicals, morpholinomethylene radicals, piperazinomethylene radicals, acrylamidomethylene radicals, dimethylaminomethylene radicals, diethylaminomethylene radicals, dibutylaminomethylene radicals, phenoxymethylene radicals, and methylmercaptomethylene radicals, and also siloxanyl radicals, which may be attached both via oxygen and via silicon to V.

Preferably radical R² comprises organyloxymethylene radicals, more preferably the methoxymethylene radical.

Examples of radical V are any desired polyvalent radicals known to date, such as, for example, polyvalent organic radicals, polyvalent silyl radicals, and boric acid radicals.

Preferably radical V comprises polyvalent organic radicals or polyvalent silyl radicals, more preferably polyvalent organic radicals.

If radical V comprises polyvalent silyl radicals, preference is given to SiO_{3/2} and SiO_{4/2}.

If radical V comprises polyvalent organic radicals, preference is given to polyvalent hydrocarbon radicals optionally substituted by nitrogen radicals and/or by oxygen radicals, and particular preference to those of the formula

W—[R⁴—R⁵—C(O)—R⁶—R_{c}⁷—]ₘ (IV)

where

W is a p-valent hydrocarbon radical, which may contain heteroatoms,

R⁴ may be identical or different and is a divalent, optionally substituted hydrocarbon radical,

R⁵ may be identical or different and is an optionally substituted hydrocarbon radical, —O— or —NR^{3′}—, where R^{3′}— has one of the definitions stated above for R³,

R⁶ may be identical or different and is an optionally substituted hydrocarbon radical, —O— or —NR^{3″}—, where R^{3″} has one of the definitions given above for R³,

R⁷ may be identical or different and is a divalent, optionally substituted hydrocarbon radical,

c is 0 or 1, and

p and m have one of the above definitions, with the proviso that p is greater than or equal to m.

Preferably W comprises trivalent, aliphatic or aromatic hydrocarbon radicals optionally containing heteroatoms, and more preferably comprises cyanurate radicals and biuret radicals, more particularly biuret radicals.

Examples of radicals R⁴ and R⁷ are, in each case independently of one another, the radicals stated for Y and Z.

Preferably R⁴ comprises divalent, optionally substituted hydrocarbon radicals having 1 to 10 carbon atoms, more preferably phenylene radicals, tolylene radicals, and hexamethylene radicals, more particularly hexamethylene radicals.

Preferably radical R⁵ comprises —NH—.

Preferably radical R⁶ comprises —O—.

Preferably R⁷, to which, in the case of c=1, the groups ([SiR₂O]ₙ—SiR₂R¹) and also, optionally, R² attach, in accordance with formula (I), comprises divalent, aliphatic, optionally substituted hydrocarbon radicals having 1 to 6 carbon atoms, more preferably propylene and methyloxyethylene radicals, more particularly methyloxyethylene radicals. If c is 0, these groups attach directly to R⁶.

With particular preference, c is 1.

The hyperbranched siloxanes (A) used in accordance with the invention have an isocyanate content of preferably 0.5% to 10% by weight, more preferably 1% to 5% by weight.

The hyperbranched siloxanes (A) used in accordance with the invention have a viscosity of preferably 100 to 10 000 mPas, more preferably 500 to 5000 mPas, in each case at 25° C.

The invention further provides hyperbranched siloxanes (A) of the formula

V—(R²)ₚ₋ₘ([SiR₂O]ₙ—SiR₂R¹)ₘ (I)

in which

V is a radical of value p,

R can be identical or different and is a monovalent, optionally substituted hydrocarbon radical,

R¹ can be identical or different and is a monovalent hydrocarbon radical which is substituted by at least one isocyanate group, and which may be interrupted by heteroatoms,

R² can be identical or different and represents monovalent radicals,

n is an integer greater than or equal to 1, preferably 1 to 1000, more preferably 5 to 500, more particularly 10 to 100,

p is an integer greater than or equal to 3, preferably 3 to 20, more preferably 3 or 4, and

m is an integer greater than or equal to 3, preferably 3 to 20, more preferably 3 to 4,

with the proviso that p is greater than or equal to m.

The hyperbranched siloxanes (A) of the invention can be prepared by processes which are commonplace in silicon chemistry.

In one preferred embodiment of the invention, the hyperbranched siloxanes (A) of the invention, of the formula (I), with V as an organic radical, are prepared by reaction of linear α,ω-aminoalkyl-functionalized, α,ω-hydroxyalkyl-functionalized siloxanes or α,ω-hydroxy-functionalized siloxanes (A1) with polyisocyanates. The reaction may be a single-stage or multistage process. If it is a two-stage process, the first step is carried out using polyisocyanate in a deficit amount relative to the siloxanes (A1), giving the hyperbranched siloxanes (A2). Then, in the next reaction step, the hyperbranched siloxanes (A2) are reacted with further polyisocyanate, which is used in an excess, such that per mole of aminoalkyl radicals or hydroxyalkyl-functional radicals in the hyperbranched siloxanes (A2) there is at least 1 mol, more particularly 2 to 10 mol, of isocyanate units used. The molar excess of isocyanates is preferably consumed at foam formation for the reaction with water.

In another preferred embodiment of the invention, hyperbranched siloxanes (A) of the invention, of the formula (I) with V as a silyl radical, are obtained in a two-stage process, in which, first of all, linear α,ω-hydroxy-terminated siloxanes (A3) are reacted with a silane that is reactive toward (A3), such as trimethoxymethylsilane, for example, in a deficit amount relative to the siloxanes (A3). This produces hyperbranched siloxanes (A4), which are then reacted with polyisocyanate, the latter being used in an excess, thus giving, per mole of hydroxyl radicals in the hyperbranched siloxanes (A4), at least 1 mol, more particularly 2 to 10 mol, of isocyanate units used. The molar excess of isocyanates is preferably consumed at the foam-forming stage, for the reaction with water.

If desired, the hyperbranched siloxane (A4) may be functionalized prior to the reaction of the polyisocyanate. This functionalization takes place preferably with sila-cycles of the formulae

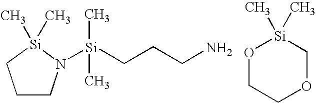

Further to the siloxanes (A), the compositions of the invention may comprise additional substances, such as, for example, isocyanates (B), fillers (C), emulsifiers (D), physical blowing agents (E), catalysts (F), chemical blowing agents (G), and additives (H).

As optionally used isocyanates (B) it is possible to use all known diisocyanates or polyisocyanates.

Preference is given to using, as polyisocyanates (B), those of the general formula

Q(NCO)_{b} (V)

where
Q is a b-functional, optionally substituted hydrocarbon radical and
b is an integer of at least 2, preferably from 2 to 10, more preferably 2 or 4, more particularly 2 to 3.

Preferably Q comprises optionally substituted hydrocarbon radicals having 4 to 30 carbon atoms, more preferably hydrocarbon radicals having 6 to 25 carbon atoms.

Examples of diisocyanates (B) are diisocyanatodiphenyl-methane (MDI), not only in the form of crude or technical MDI but also in the form of pure 4,4′ and/or 2,4′ isomers or compositions thereof, tolylene diisocyanate (TDI) in the form of its various regioisomers, diisocyanatonaphthalene (NDI), isophorone diisocyanate (IPDI), 1,3-bis(1-isocyanato-1-methyl-ethyl)benzene (TMXDI) or else hexamethylene diisocyanate (HDI). Examples of polyisocyanates (B) are polymeric MDI (p-MDI), triphenylmethane triisocyanate or biuret trimers or isocyanurate trimers of the abovementioned isocyanates. The diisocyanates and/or polyisocyanates (B) may be used alone or in a mixture.

The isocyanates (B) may be the same ones used in preparing the siloxanes (A), in particular when the process is a two-stage preparation process. In that case, if desired, isocyanate may be used in excess in the preparation of the siloxanes (A), and the resulting mixture may advantageously be used further for preparing the composition of the invention.

Where the compositions of the invention comprise isocyanates (B), the amounts in question are preferably 0.1 to 50 parts by weight, more preferably 0.1 to 40 parts by weight, more particularly 0.1 to 30 parts by weight, based in each case on 100 parts by weight of hyperbranched siloxane (A).

The compositions of the invention preferably comprise isocyanates (B).

If fillers (C) are used, the fillers in question may be all nonreinforcing fillers, i.e., fillers having a BET surface area of up to 50 m²/g, such as chalk, or reinforcing fillers, i.e., fillers having a BET surface area of at least 50 m²/g, such as carbon black, precipitated silica or fumed silica. In particular both hydrophobic and hydrophilic fumed silicas represent a preferred filler. One particularly preferred embodiment of the invention uses a hydrophobic fumed silica whose surface has been modified with trimethylsilyl groups. The fillers (C) that are used—more particularly fumed silicas—may take on a variety of functions. Thus they may be used to adjust the viscosity of the foamable mixture. In particular, however, they are able to take on a “support function” in the course of foaming, and thus lead to foams having a better foam structure. Finally, the mechanical properties of the resultant foams may also be decisively improved through the use of fillers (C)—especially through the use of fumed silica. In addition, expandable graphite may also be added as filler (C).

If the compositions of the invention comprise fillers (C), the amounts in question are preferably 0.1 to 30 parts by weight, more preferably 0.1 to 20 parts by weight, more particularly 0.1 to 15 parts by weight, based in each case on 100 parts by weight of siloxane (A).

The compositions of the invention preferably comprise fillers (C).

In many cases it is of advantage to add emulsifiers (D) to the foamable compositions. As suitable emulsifiers (D), which also serve as foam stabilizers, it is possible, for example, to use all commercial silicone oligomers that are modified with polyether side chains and that are also used in producing conventional polyurethane foams.

If emulsifiers (D) are used, the amounts in question are preferably up to 6% by weight, more preferably from 0.3% to 3% by weight, based in each case on the total weight of the foamable compositions.

The compositions of the invention preferably comprise emulsifiers (D).

Moreover, the compositions may also comprise compounds (E) which are able to act as physical blowing agents. As constituent (E) it is preferred to use low molecular mass hydrocarbons such as, for example, propane, butane or cyclopentane, dimethyl ether, fluorinated hydrocarbons such as 1,1-difluoroethane or 1,1,1,2-tetrafluoroethane or CO₂. In this case the production of foam may if desired take place exclusively by means of the physical blowing agents (E). Usually, however, the formation of foam takes place primarily through a reaction of the isocyanate-functional siloxanes with the chemical blowing agent component (G). Even in that case, though, the use of physical blowing agents (E) in combination with chemical blowing agent constituent (G) may be advantageous, in order thus to obtain foams having a relatively low density.

If the compositions of the invention comprise constituent (E), the amounts in question are from preferably 0.1 to 30 parts by weight, more preferably 0.1 to 20 parts by weight, more particularly 0.1 to 15 parts by weight, based in each case on 100 parts by weight of siloxane (A).

The compositions of the invention preferably comprise no physical blowing agent (E).

Furthermore, the foamable compositions of the invention may comprise catalysts (F) which accelerate the curing of the foam. Suitable catalysts (F) include organotin compounds. Examples are dibutyltin dilaurate, dioctyltin dilaurate, dibutyltin diacetate, dibutyltin dioctoate or dibutyltin bis(dodecylmercaptide). Moreover, tin-free catalysts (F) are contemplated as well, such as, for example, heavy-metal compounds or amines. An example of tin-free catalysts is iron(III) acetylacetonate, zinc(II) octoate, zirconium(IV) acetylacetonate and bismuth(III) neodecanoate. Examples of amines are triethylamine, tributylamine, 1,4-diazabicyclo[2.2.2]octane, N,N-bis(N,N-dimethyl-2-aminoethyl)methylamine, N,N-dimethylcyclohexylamine, N,N-di-methylphenylamine, bis-N,N-dimethylaminoethyl ether, N,N-dimethyl-2-aminoethanol, N,N-dimethylaminopyridine, N,N,N,N-tetramethyl-bis(2-aminoethylmethylamine, 1,5-diazabicyclo[4.3.0]non-5-ene, 1,8-diazabicyclo[5.4.0]-undec-7-ene, N-ethylmorpholine or N,N′-dimethylaminopyridine.

The catalysts (F) may be used individually or as mixture. If desired, the catalysts used in the preparation of the siloxanes (A) may also serve simultaneously as catalysts (F) for foam curing.

If catalyst (F) is used, the amounts in question are from preferably 0.1% to 6.0% by weight, more preferably from 0.3% to 4.0% by weight, based in each case on the total weight of the foamable composition of the invention.

The compositions of the invention preferably comprise catalysts (F).

As chemical blowing agents (G) it is possible in principle for not only water but also all compounds having preferably at least one isocyanate-reactive function to be used.

Examples of constituent (G) are aminoalkyl- or hydroxy-functional siloxanes other than component (A), monomeric alcohols, monomeric diols such as glycol, propanediol and butanediol, monomeric oligools such as pentaerythritol or trihydroxymethylethane, oligomeric or polymeric alcohols having one, two or more hydroxyl groups such as ethylene glycols or propylene glycols, water, monomeric amines having one, two or more amine functions such as ethylenediamine, hexamethylene-diamine, and also oligomeric or polymeric amines having one, two or more amine functions.

If constituent (G) is used, it preferably comprises hydroxy compounds, with water being particularly preferred.

If constituent (G) is used, the amounts are preferably 0.1 to 20 parts by weight, more preferably from 0.1 to 15 parts by weight, more particularly from 0.1 to 10 parts by weight, based in each case on 100 parts by weight of siloxane (A).

The compositions of the invention preferably comprise constituent (G).

As additives (H), furthermore, the addition of cell regulators, thixotropic agents and/or plasticizers may also be advantageous. In order to improve the fire resistance, moreover, flame retardants may be added to the foamable compositions, examples being phosphorus-containing compounds, especially phosphates and phosphonates, and also halogenated polyesters and polyols or chlorinated paraffins.

If additives (H) are used, the amounts involved are from preferably 0.1 to 30 parts by weight, more preferably from 0.1 to 20 parts by weight, more particularly from 0.1 to 15 parts by weight, based in each case on 100 parts by weight of siloxane (A).

The compositions of the invention preferably comprise no additives (H).

With regard to the components used in accordance with the invention, the components in question may in each case be one kind of such a component or else a mixture of at least two kinds of a respective component.

Preferably the compositions of the invention are those comprising

(A) siloxanes of the formula (I),

optionally

(B) isocyanates,

optionally

(C) fillers,

optionally

(D) emulsifiers,

optionally

(E) physical blowing agents,

optionally

(F) catalysts,

(G) chemical blowing agents, and

optionally

(H) additives,

the compositions of the invention comprising at least one blowing agent selected from components (E) and (G), in particular at least (G).

Aside from components (A) and, optionally, one or more of components (B) to (H), the compositions of the invention preferably comprise no further constituents.

The compositions of the invention can be prepared by any desired processes known per se, such as simple mixing of the individual components, in which case premixes of individual constituents may also be prepared. Both 1-component systems and 2-component systems may be prepared.

Where the compositions of the invention are provided in the form of 2-component systems, which is preferred, the two components of the foamable composition of the invention may comprise all of the constituents in any desired combinations and proportions, with the proviso that one component does not simultaneously comprise constituents (A) and (G) or (B) and (G).

Thus, for example, to prepare the composition of the invention, preferably a mixture comprising constituent (A), optionally constituent (B), optionally constituent (C), optionally constituent (D) and optionally constituent (H) is prepared, as component 1, and also a component 2 comprising constituent (G), optionally constituent (D), and optionally constituent (F), which are then mixed with one another to produce the foam of the invention.

It is, however, also possible—if desired—to prepare the composition of the invention by mixing all of the constituents with one another in one step. In these 1-component systems the foam is then formed preferably by using a physical blowing agent (E). After the foam has been applied it then cures by reaction with atmospheric moisture.

The compositions of the invention are preferably liquid to highly viscous and have a viscosity of preferably 250 to 10 000 mPas, more preferably 500 to 5000 mPas at 25° C.

The compositions of the invention serve preferably for the production of foams, more preferably of rigid foams or flexible foams, more particularly of flexible foams.

The present invention further provides a process for preparing silicone-containing polyurethane foams, characterized in that hyperbranched siloxanes (A) are mixed with at least one blowing agent and caused to react.

In one preferred embodiment of the process of the invention, hyperbranched siloxane (A), catalyst (F), and chemical blowing agent (G) are mixed and caused to react.

The process of the invention is carried out at temperatures of preferably 0 to 100° C., more preferably 10 to 40° C., more particularly 15 to 30° C.

The process of the invention is carried out preferably under the pressure of the surrounding atmosphere, in other words about 900 to 1100 hPa.

The process of the invention releases preferably CO₂ which is largely responsible for the development of the foam structure according to the invention.

The invention further provides foams preparable by reacting hyperbranched siloxanes (A) with at least one blowing agent.

The foams of the invention are notable for a fine, open-cell foam structure. Their mechanical properties match those of PU foams available commercially.

The foams of the invention have a density of preferably 10 to 500 kg/m³, more preferably 15 to 200 kg/m³, more particularly 20 to 120 kg/m³.

The foams of the invention can be used everywhere polyurethane foams have been used to date. More particularly they are suitable for upholstery, thermal insulation, and sound insulation.

The foamable compositions of the invention have the advantage that they can be processed in a very simple way and using the techniques known to date from PU technology.

Furthermore, the compositions of the invention have the advantage that they can be prepared with starting materials that are readily available commercially.

The compositions of the invention have the advantage, moreover, that they are easy to process and can be prepared at low viscosity.

The compositions of the invention have the advantage that polyurethane foams having low densities may be prepared.

The process of the invention for preparing silicone-containing PU foams has the advantage that it is easy to carry out.

The foams of the invention have the advantage, furthermore, that they are flexible and of extremely low flammability.

Furthermore, the foams of the invention have the advantage that they have high mechanical strengths, in particular in combination with low foam densities.

In the examples below, all parts and percentage data, unless indicated otherwise, are by weight. Unless indicated otherwise, the examples below are carried out under the pressure of the surrounding atmosphere, in other words at about 1000 hPa, and at room temperature, in other words about 20° C., or at a temperature which comes about when the reactants are combined at room temperature without additional heating or cooling. All of the viscosity data given in the examples are intended to be based on a temperature of 25° C.

### COMPARATIVE EXAMPLE 1

A solution of 50.00 g of a linear organopolysiloxane of the formula H₂N—(CH₂)₃—[Si(CH₃)₂—O]₁₂₉Si(CH₃)₂—(CH₂)₃—NH₂ in 100 ml of absolute methyl ethyl ketone under an inert gas atmosphere was admixed slowly dropwise over a period of an hour at 0° C. with 5.2 g of tolylene diisocyanate (TDI) in solution in 50 ml of absolute methyl ethyl ketone. The resulting reaction mixture, which in addition to 51.7 g of isocyanatosiloxane also contained 3.5 g of TDI, was then freed from the solvent under a pressure of 10 mbar.

20.00 g of the resulting prepolymer were admixed with 0.20 g of bis(2-dimethylaminoethyl) ether (available commercially under the name “Jeffcat® ZF-20” from Huntsman Corp., D-Hamburg) as catalyst and with 0.15 g of emulsifier (available commercially under the name Belsil® DMC 3071VP from Wacker Chemie AG, D-Munich). The resulting mixture was first processed to a homogeneous emulsion, using a high-speed KPG stirrer. Then 0.16 g of water was added rapidly and emulsification was carried out again, using a high-speed KPG stirrer, to give a homogeneous mixture. After about 5 seconds, an exothermic reaction began, with production of foam. The formation of foam was at an end after a further period of about 40 seconds, whereas heat continued to be given off for about 30 seconds. The result was a colorless, flexible, inflammable foam having a density of 130 kg/m³.

### COMPARATIVE EXAMPLE 2

A solution of 50.00 g of a linear organopolysiloxane of the formula H₂N—(CH₂)₃—[Si(CH₃)₂—O]₁₂₉Si(CH₃)₂—(CH₂)₃—NH₂ in 100 ml of absolute methyl ethyl ketone under an inert gas atmosphere was admixed slowly dropwise over a period of an hour at 0° C. with 8.7 g of tolylene diisocyanate (TDI) in solution in 50 ml of absolute methyl ethyl ketone. The resulting reaction mixture, which in addition to 51.7 g of isocyanatosiloxane also contained 6.9 g of TDI, was then freed from the solvent under a pressure of 10 mbar.

20.00 g of the resulting prepolymer were admixed with 0.20 g of bis(2-dimethylaminoethyl) ether (available commercially under the name “Jeffcat® ZF-20” from Huntsman Corp., D-Hamburg) as catalyst and with 0.15 g of emulsifier (available commercially under the name Belsil® DMC 3071VP from Wacker Chemie AG, D-Munich). The resulting mixture was first processed to a homogeneous emulsion, using a high-speed KPG stirrer. Then 0.28 g of water was added rapidly and emulsification was carried out again, using a high-speed KPG stirrer, to give a homogeneous mixture. After about 5 seconds, an exothermic reaction began, with production of foam, and ended, after a further 20 seconds, in the collapse of the foam structure.

### INVENTIVE EXAMPLE 1

60.00 g of a linear organopolysiloxane of the formula HO—(CH₂)₂—O—(CH₂)—[Si(CH₃)₂—O]₃₉Si(CH₃)₂—(CH₂)—O—(CH₂)₂—OH and 3.4 g of trifunctional isocyanate (available commercially under the name Desmodur® N3300 by Bayer MaterialScience AG, D-Leverkussen) were reacted under an inert gas atmosphere in 100 ml of absolute acetone. The reaction was catalyzed with 20 mg of tin(II) 2-ethylhexanoate and the reaction mixture was stirred at 50° C. for 1 hour. Subsequently 13.0 g of tolylene diisocyanate (TDI) were added to the reaction mixture, which was reacted for a further 30 minutes at 50° C., the hydroxyl groups of the organopolysiloxane undergoing complete consumption by reaction. The resulting reaction mixture, which in addition to 63.5 g of hyperbranched isocyanatosiloxane also contained 9.5 g of TDI, was then admixed with 20 mg of benzoyl chloride and freed from the solvent under a pressure of 10 mbar.

20.00 g of the resulting mixture were admixed with 0.20 g of bis(2-dimethylaminoethyl) ether (available commercially under the name “Jeffcat® ZF-20” from Huntsman Corp., D-Hamburg) as catalyst and with 0.10 g of emulsifier (available commercially under the name Belsil® DMC 3071VP from Wacker Chemie AG, D-Munich). The resulting mixture was first processed to a homogeneous emulsion, using a high-speed KPG stirrer. Then 0.32 g of water was added rapidly and emulsification was carried out again, using a high-speed KPG stirrer, to give a homogeneous mixture. After about 5 seconds, an exothermic reaction began, with production of foam. The formation of foam was at an end after a further period of about 40 seconds, whereas heat continued to be given off for about 30 seconds. The result was a colorless, flexible, inflammable foam having a density of 70 kg/m³.

### INVENTIVE EXAMPLE 2

60.00 g of a linear organopolysiloxane of the formula HO—(CH₂)₂—O—(CH₂)—[Si(CH₃)₂—O]₃₉Si(CH₃)₂—(CH₂)—O—(CH₂)₂—OH and 3.4 g of trifunctional isocyanate (available commercially under the name Desmodur® N3300 by Bayer MaterialScience AG, D-Leverkussen) were reacted under an inert gas atmosphere in 100 ml of absolute acetone. The reaction was catalyzed with 20 mg of tin(II) 2-ethylhexanoate and the reaction mixture was stirred at 50° C. for 1 hour. Subsequently 15.0 g of tolylene diisocyanate (TDI) were added to the reaction mixture, which was reacted for a further 30 minutes at 50° C., the hydroxyl groups of the organopolysiloxane undergoing complete consumption by reaction. The resulting reaction mixture, which in addition to 63.5 g of hyperbranched isocyanatosiloxane also contained 11.5 g of TDI, was then admixed with 20 mg of benzoyl chloride and freed from the solvent under a pressure of 10 mbar.

20.00 g of the resulting mixture were admixed with 0.20 g of bis(2-dimethylaminoethyl) ether (available commercially under the name “Jeffcat® ZF-20” from Huntsman Corp., D-Hamburg) as catalyst and with 0.10 g of emulsifier (available commercially under the name Belsil® DMC 3071VP from Wacker Chemie AG, D-Munich). The resulting mixture was first processed to a homogeneous emulsion, using a high-speed KPG stirrer. Then 0.36 g of water was added rapidly and emulsification was carried out again, using a high-speed KPG stirrer, to give a homogeneous mixture. After about 5 seconds, an exothermic reaction began, with production of foam. The formation of foam was at an end after a further period of about 40 seconds, whereas heat continued to be given off for about 30 seconds. The result was a colorless, flexible, inflammable foam having a density of 55 kg/m³.

### INVENTIVE EXAMPLE 3

60.00 g of a linear siloxane of the formula HO—[Si(CH₃)₂—O]₃₉Si(CH₃)₂—OH were first reacted with 0.33 g of methoxymethyltrimethoxysilane at 80° C. for 15 minutes in the presence of 100 ppm of lithium methoxide as catalyst. Then 0.81 g of 2,2-dimethyl-2-sila-1,4-dioxacyclohexane was added and stirring was continued with 80° C. for 30 minutes more. After the end of reaction, the hyperbranched siloxane was neutralized with 100 ppm of acetic acid and freed from by-products under reduced pressure at 10 mbar for 15 minutes. Then the product was taken up in 100 ml of absolute acetone and admixed with 13.0 g of tolylene diisocyanate. The resultant reaction mixture was then stirred for 30 minutes at 50° C. in the presence of 20 mg of tin(II) 2-ethylhexanoate as catalyst, the hydroxyl groups of the organosiloxane being consumed fully by reaction. The reaction mixture thereafter contains not only 64.5 g of hyperbranched isocyanatosiloxane but also 9.5 g of TDI. Thereafter it was admixed with 20 mg of benzoyl chloride and freed from the solvent under a pressure of 10 mbar.

20.00 g of the resulting mixture were admixed with 0.20 g of bis(2-dimethylaminoethyl) ether (available commercially under the name “Jeffcat® ZF-20” from Huntsman Corp., D-Hamburg) as catalyst and with 0.15 g of emulsifier (available commercially under the name Belsil® DMC 3071VP from Wacker Chemie AG, D-Munich). The resulting mixture was first processed to a homogeneous emulsion, using a high-speed KPG stirrer. Then 0.316 g of water was added rapidly and emulsification was carried out again, using a high-speed KPG stirrer, to give a homogeneous mixture. After about 5 seconds, an exothermic reaction began, with production of foam. The formation of foam was at an end after a further period of about 40 seconds, whereas heat continued to be given off for about 30 seconds. The result was a colorless, flexible, inflammable foam having a density of 70 kg/m³.

1.-10. (canceled)

11. A foamable composition comprising hyperbranched siloxanes (A) of the formula
V—(R²)ₚ₋ₘ([SiR₂O]ₙ—SiR₂R¹)ₘ (I)
in which
V is a radical of valence p,
R each is identical or different and is a monovalent, optionally substituted hydrocarbon radical,
R¹ each is identical or different and is a monovalent hydrocarbon radical which is substituted by at least one isocyanate group, and which is optionally interrupted by one or more heteroatoms,
R² each is identical or different and is a monovalent radical,
n is an integer greater than or equal to 1,
p is an integer greater than or equal to 3, and
m is an integer greater than or equal to 3,
with the proviso that p is greater than or equal to m.

12. The foamable composition of claim 11, wherein R¹ is a radical of the formula
—Yₐ-A-C(O)—NH—Z—NCO (II)
where
Y and Z independently of one another are divalent, optionally substituted hydrocarbon radicals optionally interrupted by heteroatoms,
A is —O— or —NR³—, wherein R³ is hydrogen or a monovalent, optionally substituted hydrocarbon radical, and
a is 0 or 1.

13. The foamable composition of claim 11, wherein a is 1.

14. The foamable composition of claim 12, wherein a is 1.

15. The foamable composition of claim 11, wherein radical V is a polyvalent organic radical or a polyvalent silyl radical.

16. The foamable composition of claim 12, wherein radical V is a polyvalent organic radical or a polyvalent silyl radical.

17. The foamable composition of claim 13, wherein radical V is a polyvalent organic radical or a polyvalent silyl radical.

18. The foamable composition of claim 14, wherein radical V is a polyvalent organic radical or a polyvalent silyl radical.

19. The foamable composition of claim 11, comprising:
(A) siloxanes of the formula (I),
(B) optionally isocyanates,
(C) optionally fillers,
(D) optionally emulsifiers,
(E) optionally physical blowing agents,
(F) optionally catalysts, and
(G) optionally chemical blowing agents,
the composition comprising at least one blowing agent (E) or (G).

20. The foamable composition of claim 19, wherein all of components (A), (B), (D) and (F) are present.

21. A hyperbranched siloxane (A) of the formula
V—(R²)ₚ₋ₘ([SiR₂O]ₙ—SiR₂R¹)ₘ (I)
in which
V is a radical of valence p,
R each is identical or different and is a monovalent, optionally substituted hydrocarbon radical,
R¹ each is identical or different and is a monovalent hydrocarbon radical which is substituted by at least one isocyanate group, and which is optionally interrupted by one or more heteroatoms,
R² each is identical or different and is a monovalent radical,
n is an integer greater than or equal to 1,
p is an integer greater than or equal to 3, and
m is an integer greater than or equal to 3,
with the proviso that p is greater than or equal to m.

22. A process for preparing a silicone-containing polyurethane foam, comprising mixing and reacting at least one hyperbranched siloxane (A) with at least one blowing agent.

23. The process of claim 22, wherein the blowing agent used is a chemical blowing agent (G).

24. A foam prepared by reacting a hyperbranched siloxane (A) with at least one blowing agent.

25. The foam of claim 24, having a density of 10 to 500 kg/m³.

26. The foam of claim 24, having a density of from 10 to less than 200 kg/m³.
